(19) United States
(12) Patent Application Publication
(10) Pub. No.: US 2017/0032027 A1
(43) Pub. Date: Feb. 2, 2017

(54) Contact Center Virtual Assistant

(71) Applicant: Nuance Communications, Inc., Burlington, MA (US)

(72) Inventors: Andrew D. Mauro, Montreal (CA); Mark Hanson, Orinda, CA (US)

(21) Appl. No.: 14/815,103

(22) Filed: Jul. 31, 2015

(51) Int. Cl. G06F 17/30; H04M 3/51

(52) U.S. Cl. CPC G06F 17/30696; H04M 3/5191; H04M 3/5133

(57) ABSTRACT

In a contact center, agents can be distracted and delayed from communicating with customers by searching for articles relevant to the customer's communication. A system automatically performing searches based on the customer's communication can therefore aid the agent. In an embodiment, a method of improving agent interaction with a user at a contact center includes determining, at a contact center, an intent of a portion of a received input from a user based on an established context of an application domain of the contact center. The method further includes mapping the determined intent to an element of an unstructured knowledge base stored in a memory. The method further includes presenting, to an agent at the contact center via a display, automated search results having the element of the one unstructured knowledge base. Therefore, the agent can quickly access search results relevant to the call and application domain.

### BACKGROUND OF THE INVENTION

In a contact center, agents receive communications from customers. These communications can be, for example, a phone call, video chat, a real time text-based chat, or an e-mail message. Agents typically read or listen to these communications and look up an answer for the customer in a database.

### SUMMARY OF THE INVENTION

In an embodiment, a method of improving agent interaction with a user includes determining, at a contact center, an intent of a portion of a received input from a user based on an established context of an application domain of the contact center. The method further includes mapping the determined intent to an element of an unstructured knowledge base stored in a memory. The method further includes presenting, to an agent at the contact center via a display, automated search results having the element of the unstructured knowledge base.

In an embodiment, one element of the unstructured knowledge base is an interactive form enabled to receive further input from an agent related to the determined intent. In an embodiment, determining the intent of the portion of a received input from a user at a contact center is partially based on an application domain of the contact center.

In an embodiment, determining the intent further includes determining a plurality of intents. The method can further include generating a list of the plurality of intents. Presenting can include presenting the automated search results including a first enhanced automated search result having an element corresponding to a first intent of the list and later presenting a second automated search result having an element corresponding to a second intent of the list.

In an embodiment, the received input is a continuous input stream, and the method further includes continuously updating (a) the determined intent of the continuous input stream, (b) the at least one element of the unstructured knowledge base to which the updated determined intent maps, and (c) the presented automated search results.

In an embodiment, the method further includes converting the input into a structured query based on the intent. Mapping the determined intent includes mapping the structured query to the element of the unstructured knowledge base.

In an embodiment, the method includes executing a command selected by the agent, the command presented in the enhanced automated search.

In an embodiment, a system for agent interaction with a user includes an intent module configured to determine, at the contact center, an intent of a portion of a received input from the user based on an established context of an application domain of the contact center. The system further includes a mapping module configured to map the determined intent to an element of a unstructured knowledge base stored in a memory. The system further includes a display module configured to present, to an agent at the contact center via a display, automated search results having an element of the unstructured knowledge base.

In an embodiment, a non-transitory computer-readable medium is configured to store instructions for improving agent interaction with a user. The instructions, when loaded and executed by a processor, cause the processor to determine, at the contact center, an intent of a portion of a received input from a user based on an established context of an application domain of the contact center. The instructions further cause the processor to map the determined intent to an element of an unstructured knowledge base stored in a memory. The instructions further cause the processor to present, to an agent at the contact center via a display, automated search results having the element of the unstructured knowledge base.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating an example embodiment of the present invention.

FIG. 2 is a flow diagram illustrating an example embodiment of a process employed by an embodiment of the present invention.

FIG. 3 is a block diagram illustrating an example embodiment of a system employed by an embodiment of the present invention.

FIG. 4 is a block diagram illustrating an example embodiment of a system employed by an embodiment of the present invention.

FIG. 5 illustrates a computer network or similar digital processing environment in which embodiments of the present invention may be implemented.

FIG. 6 is a diagram of an example internal structure of a computer (e.g., client processor/device or server computers) in the computer system of FIG. 5.

### DETAILED DESCRIPTION OF THE INVENTION

A description of example embodiments of the invention follows.

A problem with some contact centers is that the agent working at the contact center has to manually interpret the customer's question and find a knowledge base entry to help answer the query. Examples of a knowledge base entry could be an article listing troubleshooting questions, or a form for the agent to work with the customer to fill out (e.g., a create new account form). However, the agent at the contact center looking up articles and forms can create lengthy pauses for the customer, which is undesirable. In addition, in a video chat, for example, the agent further has to divert his attention from the customer to perform the search, which can create an undesirable experience for the customer.

In an embodiment of the present invention, a contact center virtual assistant automatically interprets the customer's input (e.g., voice call, text based chat, video chat, or email). The contact center virtual assistant, based on its interpretation, performs a search of knowledge bases (e.g., databases in a memory or hard disk) and presents the agent with one or more articles or forms that are likely to assist in the customer interaction. The contact center virtual assistant then presents either the article or form to the agent or a list of articles or forms for the agent from which to choose. In this manner, the agent can forgo performing a search because the system has automatically done so. This (1) saves the agent time, (2) shortens the length of the customer interaction, which is desirable for the customer, and (3) as a result of the shorter interactions, can increase the number of calls each agent can handle, which can lower operating costs for the contact center.

In an embodiment of the present invention, the contact center virtual assistant can also track multiple support tracks for the customer. For example, in the banking domain, a customer may contact an agent to say “I would like to open a savings account because I just had a baby.” A typical call track would prompt the agent to open a savings account for the customer. The contact center virtual assistant, as described above, can automatically pull up knowledge base articles and/or forms to assist the agent in opening the savings account for the customer, free of the agent's performing his own search. In addition, the agent's company may wish to use this opportunity to acknowledge that the customer had a significant life event, and further cross-sell other goods or services to the customer. The agent may automatically search for and automatically present a script to the agent to congratulate the customer. Then, either before or after opening the saving's account, the contact center virtual assistant further prompts the agent to cross sell other services that the customer may want, such as a college saving's account. Without the contact center virtual assistant, the agent may forget that the caller mentioned about the significant life event (e.g., having a baby, buying a house) and not ask any related questions. The contact center virtual assistant gives the agent added infrastructure to remember to follow up on additional information the customer states, and, further, the resources to look-up articles or forms for this additional information automatically, free of agent input.

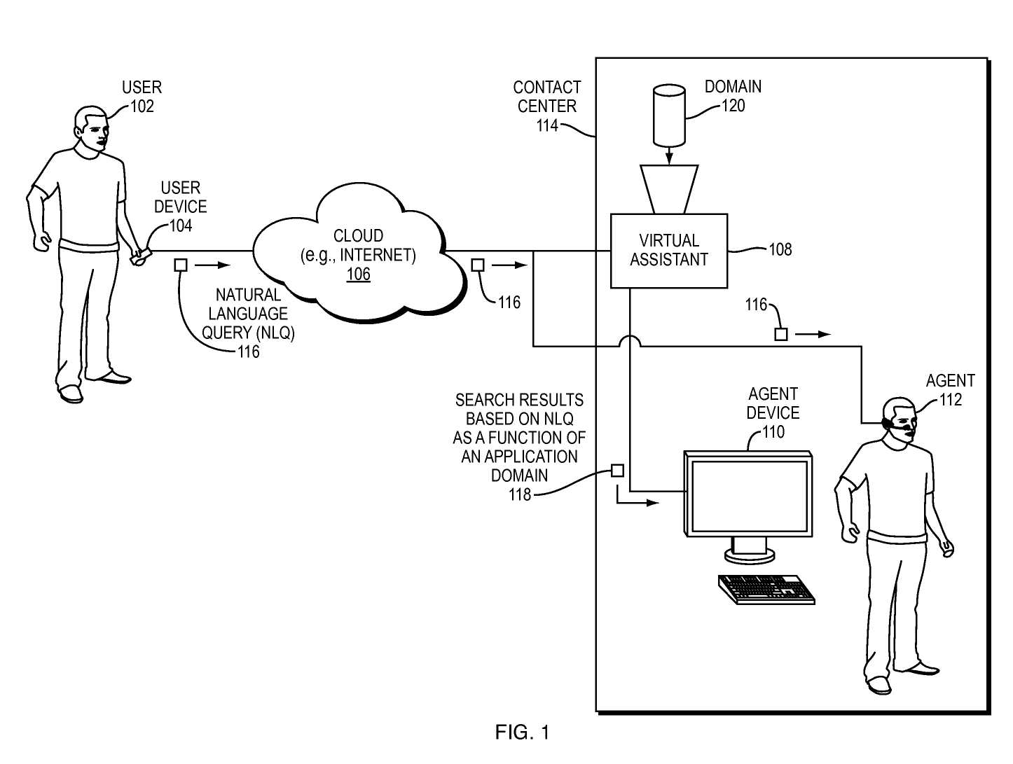

FIG. 1 is a block diagram 100 illustrating an example embodiment of the present invention. A user 102, using a user device 104 (e.g., a phone, smartphone, tablet, personal computer, workstation, etc.) sends a natural language query (NLQ) 116 to a contact center 114 via a cloud network 106 (e.g., the Internet). In certain embodiments, the cloud network 106 is bypassed, for example, by a direct phone call from the user that does not use voice over IP (VoIP).

The contact center 114 receives user input at its virtual assistant 108. The virtual assistant 108 is configured by data from an application domain 120, either by a start-up or periodic configuration or an ongoing configuration. As used herein, the application domain 120 is defined as a collection of information relating to the application of the contact center 114. For example, the application domain 120 can be a voice model having a dictionary of words specific to the application of the contact center 114 or voice models trained to understand common user queries based on the application of the contact center 114. For example, a contact center 114 having the application of “banking” can have a dictionary of words of that industry, such as “401(k),” and “Roth IRA.” This improves the accuracy of the voice recognition for the call center 114.

The application domain 120 informs the virtual assistant 108 the type of NLQs that the virtual assistant 108 may receive. The virtual assistant 108, configured by the application domain 120, can save on processing power by searching areas of interest within the application domain 120, instead of searching broader areas. This allows the virtual assistant 108 to save on processing power, memory, and respond quicker.

The virtual assistant 108 can include three systems/sub-systems (not shown): (1) a continuous transcription/natural language understanding (NLU) module; (2) a mapping module configured to map the transcribed input to a knowledge base; and (3) a display module configured to present the best results to the agent. The continuous transcription/NLU module receives, for example, voice or video input from the customer and transcribes it into a text query determining the user's intent. The mapping module correlates the transcribed query to module(s) or article(s) of knowledge base(s). Then, the display module presents the module(s) or article(s) of the knowledge base(s) to the agent, which is used to aid the interaction with the customer.

The virtual assistant 108 can then send search results 118 based on the NLQ as a function of the application domain to the agent device 110. The agent 112 can then see on its agent device 110, automatically, the search results 118 of the virtual assistant 108, and does not have to perform an additional manual search. The agent 112 at the contact center 114 also hears or reads the original NLQ 116, whether it be an audio call, text chat, email or other mode of communication. In this way, the agent 112 can still interact with the user 102 in a normal manner. However, the agent 112 is automatically presented with the search results 118 on the agent device 110. This allows the agent 112 to continue conversing with the user 102 while also having as much relevant information as possible displayed on the agent device 110. Further, the agent 112 is free of having to perform a manual search on the agent device 110, which allows the agent 112 to continue conversing with the user 102 instead of pausing to begin and refine a search manually.

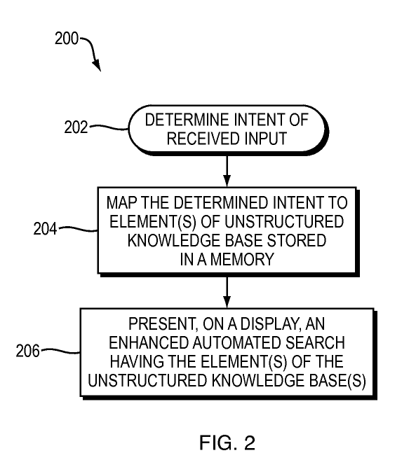

FIG. 2 is a flow diagram 200 illustrating an example embodiment of a process employed by an embodiment of the present invention. The virtual assistant determines an intent of input received from a customer (202). The virtual assistant then maps the determined intent to element(s) of an unstructured knowledge base stored in a memory or database (204). The virtual assistant then presents, on a display, an enhanced automated search having element(s) of the unstructured knowledge base(s). (206). An unstructured knowledge base as described herein refers to a knowledge base having information that is not organized in a pre-defined manner. One example of an unstructured knowledge base is a “text-heavy” knowledge base, such as a large text file. An unstructured knowledge base may, for example, lack fields (or lack a fielded form) organizing the information of the database. The unstructured knowledge base may further lack annotations or lack semantic tags of its data or documents.

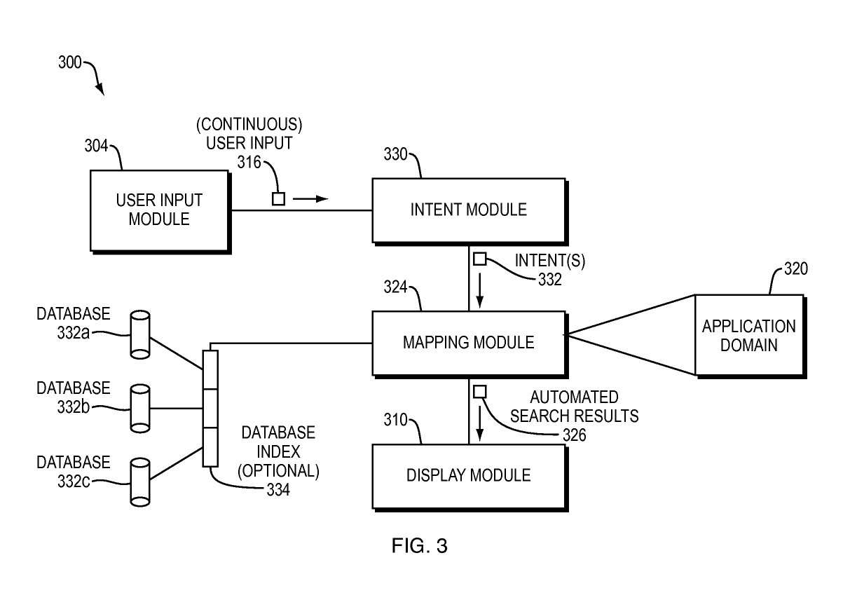

FIG. 3 is a block diagram 300 illustrating an example embodiment of a system employed by the present invention. A user input module 304, such as a voice recording device on a phone, tablet, smart phone, computer, or a keyboard for entering text, receives a customer query, for example, in the form of a voice call, video chat, text chat, or email. The user input module 304 outputs a user input 316, such as a continuous user input 316, to an intent module 330. The intent module 330 analyzes the user input 316 and generates intent(s) 332 to a mapping module 324 by determining the intent of the user input 316. The mapping module 324 then maps the intent(s) 332 to at least one unstructured knowledge base being stored in databases 332a-c and optionally indexed via a database index 334. The mapping module 324 further receives the application domain 320. The mapping module 324 uses the application domain to filter the mappings of the intent(s) 332 to respective databases within the application domain 320. In other embodiments, a person of ordinary skill in the art can recognize that the intent module 330 also can filter its intent determination based on the application domain 320.

The mapping module 324, based on the selected databases 332a-c, generates automated search results 326 by applying the intent(s) 332 to articles or information stored in the selected databases 332a-c. The display module 310 can then automatically display the automated search results 326 to an agent, aiding the process of helping the customer who generated the user input 316.

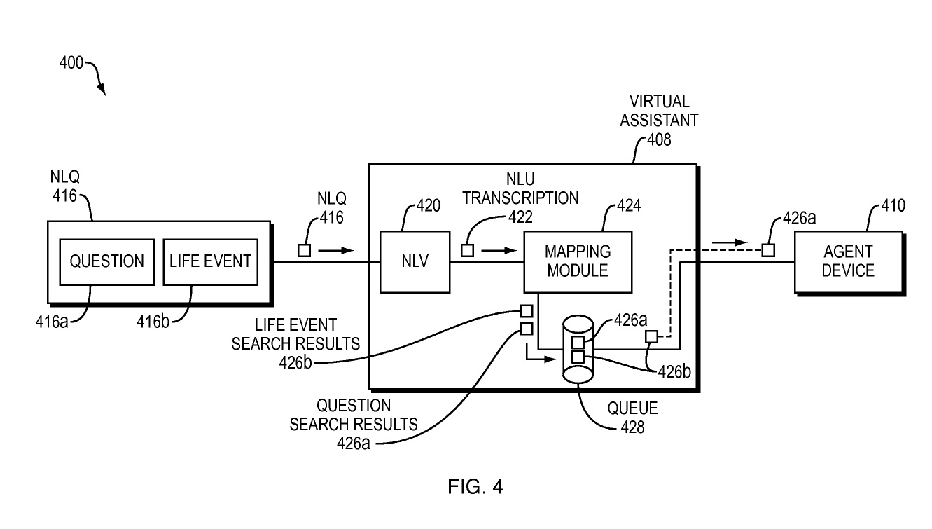

FIG. 4 is am embodiment of a block diagram 400 illustrating an example embodiment of a system employed by the present invention. A virtual assistant 408 receives an NLQ 416 having a question 416a and a life event 416b. A natural language understanding (NLU) module 420 of the virtual assistant 408 receives the NLQ 416 and generates an NLU transcription 422. A mapping module 424 analyzes the NLU transcription 422 and generates search results based on configured knowledge bases in the application domain of the virtual assistant 408. The mapping module 424 may generate two (or more) sets of search results: question search results 426a and life event search results 426b. The virtual assistant 408 stores both search results 426a-b in a memory, in a data structure such as a queue 428; however, a person of ordinary skill in the art could envision using other data structures. The agent device 410, for example on a display module, then shows the search results to an agent using the system one by one. For example, first, the display unit 410 can show the agent the question search results 426a. The agent can then converse with the customer who generated the NLQ 416 about the question 416a until the customer's question 416a is resolved.

After the agent finishes conversing with the user regarding the question 416a, the agent can indicate to its agent device 410 that it has resolved the user's issue with respect to question 416a. Without embodiments of the present invention, the agent may then forget that the user's original NLQ 416 additionally mentioned the life event 416b. For example, in a banking application domain, the life event 416b can be any event in a person's life that may be relevant to banking services, such as having a baby, buying a house, renovating a house, or sending a child to college or private school. The life event 416b can also be any opportunity for the agent to sell a service or provide additional relevant information to the user. In other embodiments, the life event 416b can be an additional question. In other embodiments still, the NLQ 416 can include any number of questions 416a and life events 416b.

As described above, the virtual assistant 408 stores both question search results 426a and life event search results 426b in the queue 428. The virtual assistant 408 can delay sending the life event search results 426b to the agent device 410 until the agent has indicated at the agent device 410 that the question 416a is resolved. Upon resolution of the question 416a, the agent device can send a signal (not shown) to the virtual assistant 408 requesting a next search result. The virtual assistant can then load the life event search results 426b from the queue 428 to send to the agent device 410. The agent can then proceed by discussing a script or other information corresponding to the life event search results 426b. After resolving any questions related to the life event search results 426b, the agent can indicate at the agent device 410 that it has resolved the life event 416b. The agent device 410 sends a signal to the virtual assistant 408 that the life event 416b has been resolved, and the virtual assistant 408 can determine whether any more storage results stored in the queue 428 can be sent to the agent device 410. In this particular example, the life event search results 426b are the last search results, so the virtual assistant 408 does not send further search results to the agent device 410. However, in a case where additional search results are in the queue 428, the virtual assistant 408 can send those to the agent device 410 until the queue 428 is empty.

The virtual assistant can further receive additional NLQs 416, or analyze a continuous stream of audio data/text data as a continuous NLQ 416, further continuously filling the queue 428 with additional search results. The virtual assistant 408 can implement a filter to prevent the queue 428 from including duplicate search results. The queue 428 can also be, in embodiments, another data structure, such as a tree, such that each node follows a conversation path. For example, a customer calling a bank may initially as “I would like to apply for a mortgage for an addition to our house that we built because we are expecting a child in six months.” The mapping module of the virtual assistant would gather three search results: (1) mortgage application search results; (2) homeowner's insurance update search results; and (3) the child's bank account search results. Each search result may be stored in a node of a tree. As the virtual assistant 408 monitors the user's continuous input, it may create additional nodes with additional search results as children nodes to each respective parent search result. For example, as the system presents the “child's bank account search results” node, the following exchange may occur:
Agent: “You mentioned you are having a child soon. Would you be interested in opening a savings account, certificate of deposit, or college fund for him or her?”
Customer: “That's a good idea, I've been meaning to do open a college fund for my 5-year-old son as well.”

The virtual assistant 408 can then further generate search results for “opening a college fund for the customer's 5-year-old son.” In addition, the virtual assistant 408 can further generate search results for “opening a savings account or a certificate of deposit for the customer's 5-year-old son.” Both of these search result nodes can be child nodes of the “child's bank account search results” node of the tree. This way, when the virtual assistant resolves the search result of the parent node, it can move on to the child nodes in an order that makes sense for the customer. In this manner, the virtual assistant can progress from asking the customer about accounts for his upcoming child, before asking for a college fund for his 5-year-old son and then other accounts for his 5-year-old son.

A person of ordinary skill in the art can further recognize that a queue or tree are merely examples of data structures that can store the search results in a memory. A person of ordinary skill in the art can further recognize that different methods can load the search results from the memory, based on the type of data structure storing the search results.

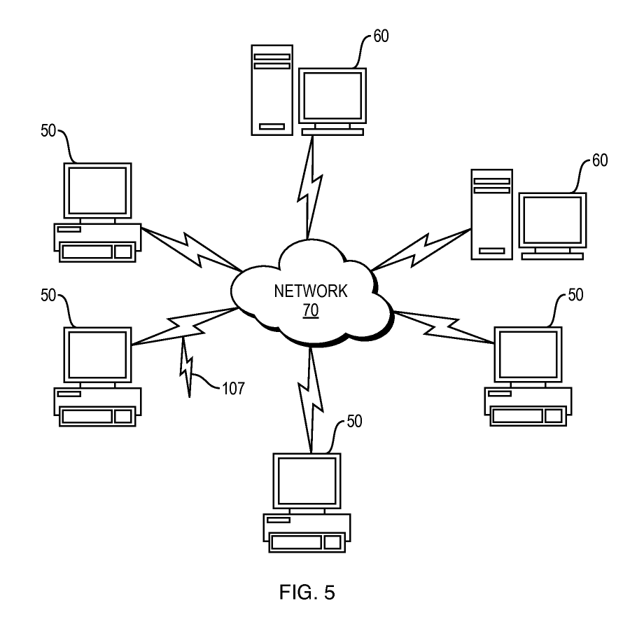

FIG. 5 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

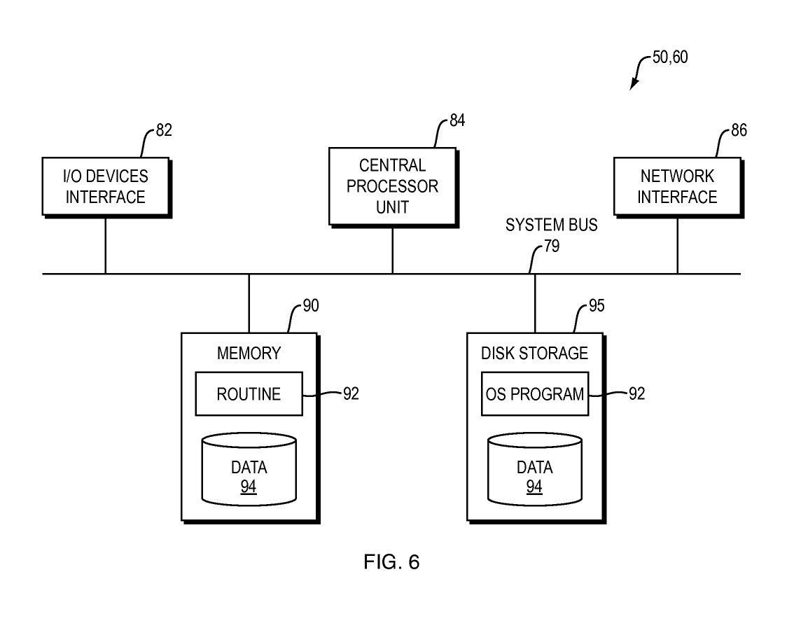

FIG. 6 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., user input module, intent module, mapping module, display module, virtual assistant). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

While this invention has been particularly shown and described with references to example embodiments thereof, it will be understood by those skilled in the art that various changes in form and details may be made therein without departing from the scope of the invention encompassed by the appended claims.

What is claimed is:

1. A method of improving agent interaction with a user, the method comprising:
determining, at a contact center, an intent of at least a portion of a received input from a user based on an established context of an application domain of the contact center;
mapping the determined intent to at least one element of at least one unstructured knowledge base stored in a memory; and
presenting, to an agent at the contact center via a display, automated search results having the at least one element of the at least one unstructured knowledge base.

2. The method of claim 1, wherein the at least one element of the at least one unstructured knowledge base is an interactive form enabled to receive further input from an agent related to the determined intent.

3. The method of claim 1, wherein determining the intent of the at least portion of a received input from a user at a contact center is at least partially based on the application domain of the contact center.

4. The method of claim 1, wherein determining the intent further includes determining a plurality of intents, and the method further comprises:
generating a list of the plurality of intents;
wherein presenting the automated search results includes presenting a first enhanced automated search result having at least one element corresponding to a first intent of the list and later presenting a second automated search result having at least one element corresponding to a second intent of the list.

5. The method of claim 1 wherein the received input is a continuous input stream, and wherein the method further comprises:
continuously updating (a) the determined intent of the continuous input stream, (b) the at least one element of the unstructured knowledge base to which the updated determined intent maps, and (c) the presented automated search results.

6. The method of claim 1, further comprising converting the input into a structured query based on the intent; and
wherein mapping the determined intent includes mapping the structured query to the at least one element of at least one unstructured knowledge base.

7. The method of claim 1, further comprising executing a command selected by the agent, the command presented in the enhanced automated search.

8. A system for agent interaction with a user, the system comprising:
an intent module configured to determine, at a contact center, an intent of at least a portion of a received input from a user based on an established context of an application domain of the contact center;
a mapping module configured to map the determined intent to at least one element of at least one unstructured knowledge base stored in a memory; and
a display module configured to present, to an agent at the contact center via a display, automated search results having the at least one element of the at least one unstructured knowledge base.

9. The system of claim 8, wherein the at least one element of the at least one unstructured knowledge base is an interactive form enabled to receive further input from an agent related to the determined intent.

10. The system of claim 8, wherein determining the intent of the at least portion of a received input from a user at a contact center is at least partially based on the application domain of the contact center.

11. The system of claim 8, wherein determining the intent further includes determining a plurality of intents, and the system further comprises:
a tracking module configured to generate a list of the plurality of intents;
wherein the display module is further configured to present the automated search results including a first enhanced automated search result having at least one element corresponding to a first intent of the list and later present a second automated search result having at least one element corresponding to a second intent of the list.

12. The system of claim 8, wherein:
the received input is a continuous input stream;
the intent module is further configured to continuously update the determined intent of the continuous input stream;
the mapping module is further configured to continuously update the at least one element of the unstructured knowledge base to which the determined intent maps; and
the display module is further configured to continuously update the presented automated search results.

13. The system of claim 8, further comprising:
a conversion module configured to convert the input into a structured query based on the intent; and
wherein mapping the determined intent includes mapping the structured query to the at least one element of at least one unstructured knowledge base.

14. The system of claim 8, further comprising an execution module configured to execute a command selected by the agent, the command presented in the enhanced automated search

15. A non-transitory computer-readable medium configured to store instructions for improving agent interaction with a user, the instructions, when loaded and executed by a processor, causes the processor to:
determine, at a contact center, an intent of at least a portion of a received input from a user based on an established context of an application domain of the contact center;
map the determined intent to at least one element of at least one unstructured knowledge base stored in a memory; and
present, to an agent at the contact center via a display, automated search results having the at least one element of the at least one unstructured knowledge base.

16. The non-transitory computer-readable medium of claim 15, wherein the at least one element of the at least one unstructured knowledge base is an interactive form enabled to receive further input from an agent related to the determined intent.

17. The non-transitory computer-readable medium of claim 15, wherein determining the intent of the at least portion of a received input from a user at a contact center is at least partially based on the application domain of the contact center.

18. The non-transitory computer-readable medium of claim 15, wherein determining the intent further includes determining a plurality of intents, and the instructions further cause the processor to:
generate a list of the plurality of intents;
wherein presenting the automated search results includes presenting a first enhanced automated search result having at least one element corresponding to a first intent of the list and later presenting a second automated search result having at least one element corresponding to a second intent of the list.

19. The non-transitory computer-readable medium of claim 15, wherein the received input is a continuous input stream, and the instructions further cause the processor to:
continuously update (a) the determined intent of the continuous input stream, (b) the at least one element of the unstructured knowledge base to which the updated determined intent maps, and (c) the presented automated search results.

20. The non-transitory computer-readable medium of claim 15, wherein the instructions further cause the processor to convert the input into a structured query based on the intent; and
wherein mapping the determined intent includes mapping the structured query to the at least one element of at least one unstructured knowledge base.
